(19) United States
(12) Patent Application Publication
(10) Pub. No.: US 2026/0367739 A1
(43) Pub. Date: Nov. 19, 2026

(54) ELECTRONIC DEVICE AND METHOD OF DRIVING SAME

(71) Applicant: Samsung Display Co., Ltd., Yongin-si (KR)

(72) Inventors: Bongil KANG, Yongin-si (KR); Min-Hong Kim, Yongin-si (KR); Sangkook Kim, Yongin-si (KR)

(73) Assignee: Samsung Display Co., Ltd., Yongin-si (KR)

(21) Appl. No.: 19/425,262

(22) Filed: Dec. 18, 2025

(30) Foreign Application Priority Data
May 13, 2025 (KR) 10-2025-0062100

(51) Int. Cl. G06F 3/041; G06F 3/044

(52) U.S. Cl. CPC G06F 3/04186; G06F 3/04164; G06F 3/04182; G06F 3/0443; G06F 3/0446; G06F 2203/04111

(57) ABSTRACT

Disclosed is an electronic device including a display layer, a sensor layer, and a sensor driver. The sensor driver includes a touch sensor determining a touch input based on a first threshold value and determining a touch end based on a second threshold value less than the first threshold value, a memory storing the first capacitance change amount, a comparator comparing the first capacitance change amount stored in the memory with a second capacitance change amount, and a threshold value setter changing the second threshold value to a third threshold value, when the second capacitance change amount is greater than the first capacitance change amount. During a second sensing frame, the touch sensor determines the touch input based on the second capacitance change amount based on the first threshold value and then determines the touch end based on the third threshold value.

### CROSS-REFERENCE TO RELATED APPLICATIONS

This application claims priority under 35 U.S.C. § 119 to of the benefit of Korean Patent Application No. 10-2025-0062100, filed on May 13, 2025, in the Korean Intellectual Property Office, the disclosure of which is incorporated by reference herein in its entirety.

### BACKGROUND

### Field

Embodiments of the disclosure relate to an electronic device with improved reliability and a method of driving the electronic device.

### Description of Related Art

An electronic device includes a display layer, which displays an image, a display driver, which transmits a signal to the display layer, a sensor layer disposed on the display layer, and a sensor driver, which transmits a driving signal to the sensor layer.

The sensor layer which is a type of information input device may be provided and used in the electronic device. For an example, the sensor layer may be attached on one surface of the display layer or may be integrally formed with the display layer. The user may input information by pressing or touching the sensor layer while viewing an image displayed on a screen of the electronic device.

### SUMMARY

Embodiments of the disclosure provide an electronic device capable of improving reliability and a method of driving the electronic device.

According to an embodiment, an electronic device may include a display layer, a sensor layer that is disposed on the display layer and senses a touch in each sensing frame, and a sensor driver that drives the sensor layer. The sensor driver may include a touch sensor that determines a touch input based on a first capacitance change amount received during a first sensing frame of the plurality of sensing frames based on a first threshold value and then determines a touch end based on a second threshold value being less than the first threshold value, a memory that stores the first capacitance change amount, a comparator that compares the first capacitance change amount stored in the memory with a second capacitance change amount received during a second sensing frame of the plurality of sensing frames, and a threshold value setter that changes the second threshold value to a third threshold value, based on the second capacitance change amount being greater than the first capacitance change amount. During the second sensing frame, the touch sensor may determine the touch input based on the second capacitance change amount based on the first threshold value and may determine the touch end based on the third threshold value.

The sensor layer may include a first sensing electrode extending in a first direction, and a second sensing electrode extending in a second direction intersecting the first direction.

The first sensing electrode may include a plurality of first portions extending in the first direction and a second portion between the plurality of first portions, and the plurality of first portions and the second portion may be in the same layer.

The second sensing electrode may include a bridge pattern extending in the second direction and a plurality of sensing patterns connected to the bridge pattern and may be spaced in the second direction, and the plurality of sensing patterns and the bridge pattern may be in different layers.

The first capacitance change amount or the second capacitance change amount may be calculated based on a mutual capacitance between the first sensing electrode and the second sensing electrode.

The third threshold value may be equal to the first threshold value.

Based on an event that the first capacitance change amount or the second capacitance change amount exceeds zero, the touch sensor may determine that the touch start is occurred.

The sensor layer may have a first temperature during the first sensing frame, and the sensor layer may have a second temperature higher than the first temperature during the second sensing frame.

The first capacitance change amount may increase by a touch change amount after a touch start.

The second capacitance change amount may increase by the touch change amount after the touch start and then further increases by a temperature change amount based on the second temperature.

After the touch end, the second capacitance change amount may be greater than or equal to the second threshold value and less than or equal to the third threshold value.

Based on an event that the first capacitance change amount or the second capacitance change amount is less than the first threshold value during determination of the touch input, the touch sensor may determine that the touch end is occurred.

Based on the second capacitance change amount being greater than the first capacitance change amount, the threshold value setter may change the second threshold value to the third threshold value.

The sensor driver may further include a signal generation circuit that outputs a driving signal to the first sensing electrode; and an input detection circuit that receives a sensing signal from the second sensing electrode.

The input detection circuit may convert the sensing signal into the first capacitance change amount or the second capacitance change amount.

According to an embodiment, a method of driving an electronic device may include determining a touch input based on a first capacitance change amount received during a first sensing frame of a plurality of sensing frames based on a first threshold value and determining a touch end based on a second threshold value less than the first threshold value, storing the first capacitance change amount, comparing the first capacitance change amount with a second capacitance change amount received during a second sensing frame of the plurality of sensing frames, changing the second threshold value to a third threshold value, based on the second capacitance change amount being greater than the first capacitance change amount, and determining the touch input based on the second capacitance change amount received during the second sensing frame based on the first threshold value and determining the touch end based on the third threshold value.

The determining of the touch input based on the first capacitance change amount and the determining of the touch end may include outputting a driving signal to the plurality of sensing frames, receiving a sensing signal based on the driving signal, and converting the sensing signal into the first capacitance change amount or the second capacitance change amount.

The method may further include determining a touch start based on the event that the first capacitance change amount or the second capacitance change amount exceeds zero.

The determining of the touch input based on the first capacitance change amount and the determining of the touch end may include determining the touch end based on the event that the first capacitance change amount is less than the first threshold value during determination of the touch input.

The comparing of the first capacitance change amount with the second capacitance change amount received during the second sensing frame of the plurality of sensing frames may include changing the second threshold value to the third threshold value, based on the second capacitance change amount being greater than the first capacitance change amount.

According to an embodiment, an electronic device may include: a sensor layer configured to sense a touch; and a control circuit configured to: detect a first capacitance change amount caused by the touch during a first sensing frame; detect a second capacitance change amount caused by the touch during a second sensing frame; compare the second capacitance change amount with the first capacitance change amount; increase a threshold value based on the second capacitance change amount being greater than the first capacitance change amount; and determine a touch end based on the increased threshold value, wherein the increased threshold value may be determined to compensate for a capacitance variation of the sensor layer corresponding to a temperature change of the sensor layer caused by the touch.

### BRIEF DESCRIPTION OF DRAWINGS

The above and other objects and features of the disclosure will become apparent by describing in detail embodiments thereof with reference to the accompanying drawings.

FIG. 1 is a block diagram of an electronic device according to an embodiment of the disclosure.

FIG. 2 illustrates schematic views of electronic devices according to various embodiments.

FIG. 3 is a perspective view of an electronic device according to an embodiment of the disclosure.

FIG. 4 is a block diagram illustrating an electronic device according to an embodiment of the disclosure and a hand of a user.

FIG. 5 is a cross-sectional view of a display module according to an embodiment of the disclosure.

FIG. 6 is a cross-sectional view of a display module taken along line I-I’ of FIG. 3, according to an embodiment of the disclosure.

FIG. 7 is a block diagram of a display layer and a display driver according to an embodiment of the disclosure.

FIG. 8 is a block diagram of a sensor layer and a sensor driver according to an embodiment of the disclosure.

FIG. 9 is a cross-sectional view taken along line II-II’ of FIG. 8, according to an embodiment of the disclosure.

FIG. 10 is an enlarged plan view of a cross area of FIG. 8 according to an embodiment of the disclosure.

FIG. 11 is a block diagram of a sensor driver according to an embodiment of the disclosure.

FIG. 12 is a graph illustrating a capacitance change amount for each frame according to an embodiment of the disclosure.

FIG. 13 is a flowchart illustrating a method of driving an electronic device according to an embodiment of the disclosure.

### DETAILED DESCRIPTION

The embodiments described herein are non-limiting example embodiments, and thus, the disclosure is not limited thereto and may be realized in various other forms. In the disclosure, the expression that a first component (or region, layer, part, portion, etc.) is “on”, “connected with”, or “coupled with” a second component means that the first component is directly on, connected with, or coupled with the second component or means that a third component is interposed therebetween. Further, when two or more elements (or components, or layers) are described as being “electrically connected,” these two or more elements may be in a state of electrically connected or being configured to be electrically connected when power is supplied to a device including the two or more elements.

The same sign refers to the same element. Also, in drawings, the thickness, ratio, and dimension of components on are exaggerated for effectiveness of description of technical contents. The expression “and/or” includes one or more combinations which associated components are capable of defining.

Although the terms “first”, “second”, etc. may be used to describe various components, the components should not be construed as being limited by the terms. The terms are only used to distinguish one component from another component. For example, without departing the scope of the inventive concept, a first component may be referred to as a second component, and similarly, a second component may be referred to as a first component. The articles “a”, “an”, and “the” are singular in that they have a single referent, but the use of the singular form should not preclude the presence of more than one referent.

Also, the terms “under”, “below”, “on”, “above”, etc. are used to describe the correlation of components illustrated in drawings. The terms are relative and are described with respect to a direction indicated in the drawing.

It will be understood that the terms “include”, “comprise”, “have”, etc. specify the presence of features, numbers, steps, operations, elements, or components, described in the disclosure, or a combination thereof, not precluding the presence or additional possibility of one or more other features, numbers, steps, operations, elements, or components or a combination thereof.

Unless defined otherwise, all terms (including technical and scientific terms) used herein have the same meaning as commonly understood by one of ordinary skill in the art to which this disclosure belongs. In addition, terms such as terms defined in commonly used dictionaries should be interpreted as having a meaning consistent with the meaning in the context of the related technology, and should not be interpreted as an ideal or excessively formal meaning unless explicitly defined in the disclosure.

Embodiments of the disclosure will be described with reference to drawings.

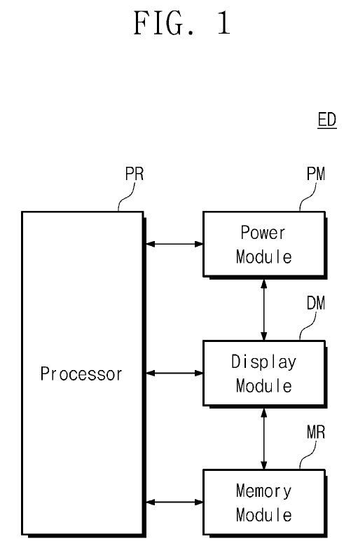

FIG. 1 is a block diagram of an electronic device according to an embodiment of the disclosure.

An electronic device according to an embodiment of the disclosure may be provided in various forms/shapes. The electronic device according to an embodiment of the disclosure may further include a module or device which has any other additional functions.

Referring to FIG. 1, an electronic device ED according to an embodiment may include a display module DM, a processor PR, a memory module MR, and a power module PM.

The processor PR may include at least one of a central processing unit (CPU), an application processor (AP), a graphics processing unit (GPU), a communication processor (CP), an image signal processor (ISP), and a controller. The processor PR may control the power module PM, the display module DM, and the memory module MR.

Data and information for operations of the processor PR or the display module DM may be stored in the memory module MR. When the processor PR executes an application stored in the memory module MR, an image data signal and/or an input control signal may be transferred to the display module DM, and the display module DM may process the provided signal to output image information through a display screen.

The power module PM may include a power supply module such as a power adapter or a battery device and a power conversion module which converts the power supplied by the power supply module into operating voltages required for operations of the electronic device ED.

The display module DM may operate based on electrical signals. Some individual modules which are functionally included in one module may be included in the display module DM, and others individual module may be implemented in the electronic device ED independently of the display module DM.

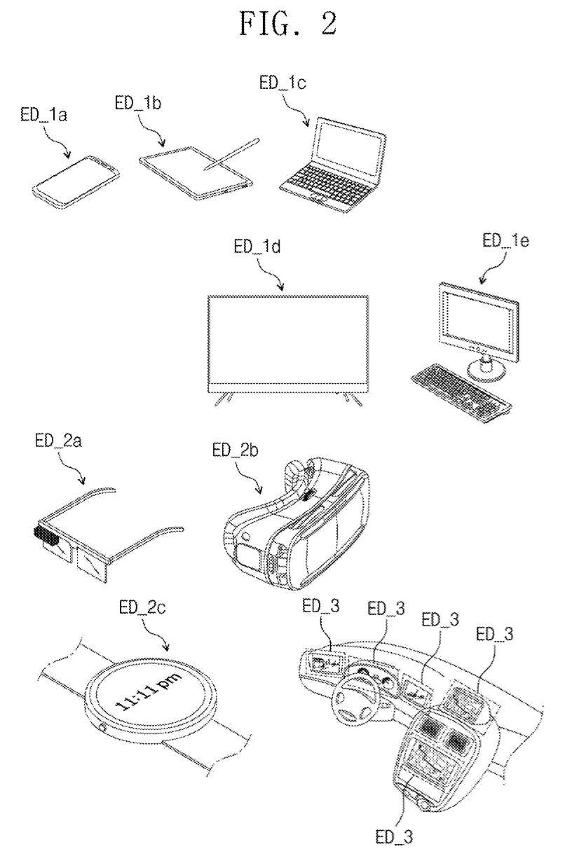

FIG. 2 illustrates schematic views of electronic devices according to various embodiments.

Referring to FIG. 2, an electronic device according to various embodiments may be a wearable electronic device including a display module such as smart glasses ED-2a, a head-mounted display ED-2b, and a smartwatch ED-2c, as well as an image display device such as a smartphone ED-1a, a tablet PC ED-1b, a laptop ED-1c, a television (TV) ED-1d, and a desktop monitor ED-1e.

For example, the electronic device according to various embodiments may be applied within a transport device such as a vehicle and may provide various information to the user through images. For example, the electronic device according to the disclosure may be provided in the form of an automotive electronic device ED-3 including display modules such as an instrument panel, a center fascia, a center information display (CID) disposed on a dashboard, and a room mirror display of a vehicle.

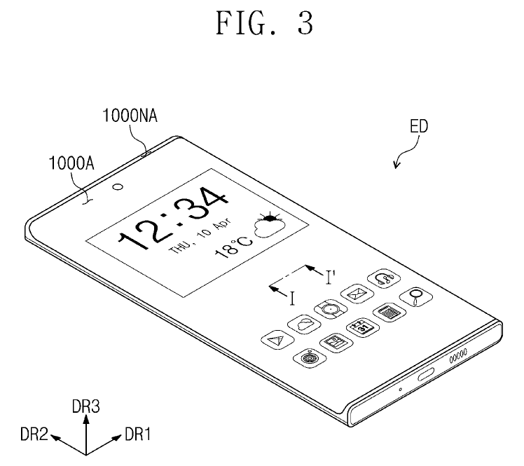

FIG. 3 is a perspective view of an electronic device according to an embodiment of the disclosure.

Referring to FIG. 3, the electronic device ED may be activated based on electrical signals. For example, the electronic device ED may include a mobile phone, a foldable mobile phone, a laptop, a television, a tablet, an automotive navigation system, a game console, or a wearable device, but the disclosure is not limited thereto. FIG. 3 illustrates that the electronic device ED is a mobile phone.

An active area 1000A and a non-active area 1000NA may be defined in the electronic device ED. The electronic device ED may display images through the active area 1000A. The active area 1000A may include a surface defined by a first direction DR1 and a second direction DR2. The peripheral area 1000NA may surround the active area 1000A.

A thickness direction of the electronic device ED may be parallel to a third direction DR3 intersecting the first direction DR1 and the second direction DR2. Accordingly, front surfaces (or top/upper surfaces) and rear surfaces (or bottom/lower surfaces) of members constituting the electronic device ED may be defined with respect to the third direction DR3.

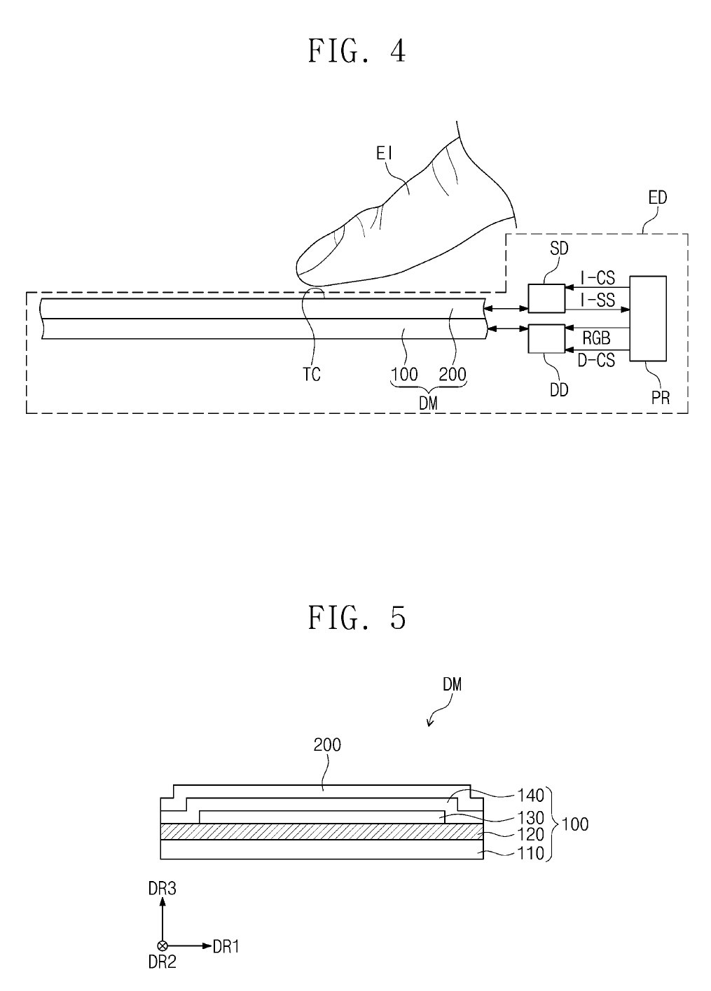

FIG. 4 is a block diagram illustrating an electronic device according to an embodiment of the disclosure and a hand of a user.

Referring to FIG. 4, the electronic device ED may include the display module DM, a display driver DD, a sensor driver SD, and the processor PR.

The display module DM may include a display layer 100 and a sensor layer 200.

The display layer 100 may generate an image. The display layer 100 may be a light emitting display layer. For example, the display layer 100 may be an organic light emitting display layer, a quantum dot display layer, a micro-LED display layer, or a nano-LED display layer.

The sensor layer 200 may be disposed on the display layer 100. The sensor layer 200 may sense an external input applied from the outside. For example, the sensor layer 200 may sense a touch input TC caused by a fingertip EI of the user, which is an external input.

The processor PR may control overall operations of the electronic device ED. For example, the processor PR may control operations of the display driver DD and the sensor driver SD. The processor PR may include at least one microprocessor, and the processor PR may be referred to as a “host”.

The display driver DD may control the display layer 100. The processor PR may further include a graphics controller. The display driver DD may receive image data RGB and a control signal D-CS from the processor PR. The control signal D-CS may include various signals. For example, the control signal D-CS may include an input vertical synchronization signal, an input horizontal synchronization signal, a main clock, a data enable signal, and the like. Based on the control signal D-CS, the display driver DD may generate a vertical synchronization signal and a horizontal synchronization signal for controlling the timing to provide a signal to the display layer 100.

The sensor driver SD may control the sensor layer 200. The sensor driver SD may receive a control signal I-CS from the processor PR. The control signal I-CS may include a mode selection signal for determining a driving mode of the sensor driver SD and a clock signal. The sensor driver SD may operate in a mode of sensing the touch input TC caused by the fingertip EI of the user, based on the control signal I-CS.

The sensor driver SD may calculate coordinates of the touch input TC based on the signal received from the sensor layer 200 and may provide a coordinate signal I-SS including coordinate information to the processor PR.

The sensor driver SD and the processor PR may be connected to each other through either inter-integrated circuit (I²C) communication or serial peripheral interface (SPI) communication.

The processor PR may perform an operation corresponding to the user input based on the coordinate signal I-SS. For example, the processor PR may drive the display driver DD based on the coordinate signal I-SS such that a new application image may be displayed through the display layer 100.

FIG. 5 is a cross-sectional view of a display module according to an embodiment of the disclosure.

Referring to FIG. 5, the display module DM may include the display layer 100 and the sensor layer 200.

The display layer 100 may include a base layer 110, a circuit layer 120, a light emitting element layer 130, and an encapsulation layer 140.

The base layer 110 may provide a base surface on which the circuit layer 120 is disposed. The base layer 110 may be a glass substrate, a metal substrate, a polymer substrate, and the like. However, the disclosure is not limited thereto. For example, the base layer 110 may include an inorganic layer, an organic layer, or a composite material layer.

The circuit layer 120 may be disposed on the base layer 110. The circuit layer 120 may include an insulating layer, a semiconductor pattern, a conductive pattern, a signal line, and the like. The insulating layer, the semiconductor layer, and the conductive layer may be formed on the base layer 110 by a coating process or a deposition process, and the insulating layer, the semiconductor layer, and the conductive layer may then be selectively patterned through a plurality of photolithography processes. Then, the semiconductor pattern, the conductive pattern, and the signal line, which are included in the circuit layer 120, may be formed.

The light emitting element layer 130 may be disposed on the circuit layer 120 and may include a light emitting element. For example, the light emitting element layer 130 may include an organic light emitting material, an inorganic light emitting material, an organic-inorganic light emitting material, a quantum dot, a quantum rod, a micro-LED, or a nano-LED.

The encapsulation layer 140 may be disposed on the light emitting element layer 130, and may protect the light emitting element layer 130 from foreign substances such as moisture, oxygen, and dust particles.

The sensor layer 200 may be disposed on the display layer 100, and may sense an external input applied from the outside. The external input may be a user input. The user input may include various types of external inputs such as a part of a user’s body, a light, heat, a pen, a stylus, or pressure.

The sensor layer 200 may be formed on the display layer 100. The sensor layer 200 and the display layer 100 may be formed by the same process. For example, the sensor layer 200 may be expressed as being directly disposed on the display layer 100. The expression “being directly disposed” may indicate that a third component is not interposed between the sensor layer 200 and the display layer 100. For example, a separate adhesive member may not be interposed between the sensor layer 200 and the display layer 100. In another example, the sensor layer 200 may be coupled to the display layer 100 through an adhesive member. The adhesive member may include a typical adhesive or sticking agent.

For example, the display module DM may further include an anti-reflection layer and an optical layer disposed on the sensor layer 200. The anti-reflection layer may reduce the reflectance of external light incident on the display module DM. The optical layer may improve the front luminance of the display module DM by controlling a direction of a light emitted from the display layer 100.

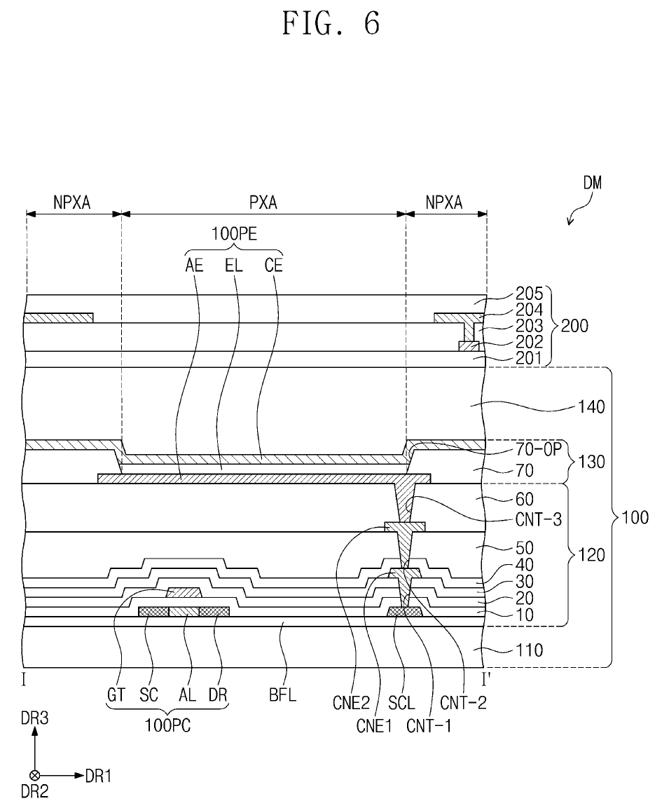

FIG. 6 is a cross-sectional view of a display module taken along line I-I’ of FIG. 3, according to an embodiment of the disclosure.

Referring to FIG. 6, at least one inorganic layer may be formed on an upper surface of the base layer 110. The inorganic layer may include at least one of aluminum oxide, titanium oxide, silicon oxide, silicon nitride, silicon oxynitride, zirconium oxide, or hafnium oxide. The inorganic layer may be formed as a single layer or multiple layers. The multiple inorganic layers may function a barrier layer and/or a buffer layer. In an embodiment, the display layer 100 may include a buffer layer BFL.

The buffer layer BFL may improve a bonding strength between the base layer 110 and a semiconductor pattern. The buffer layer BFL may include at least one of silicon oxide, silicon nitride, and silicon oxynitride. For example, the buffer layer BFL may include a silicon oxide layer and a silicon nitride layer, which are stacked alternately.

The semiconductor pattern may be disposed on the buffer layer BFL. The semiconductor pattern may include polysilicon. However, the disclosure is not limited thereto. For example, the semiconductor pattern may include amorphous silicon, low-temperature polycrystalline silicon, or an oxide semiconductor.

FIG. 6 illustrates a portion of the semiconductor pattern, and a remaining portion of the semiconductor pattern may be further disposed in other area. The semiconductor patterns may be arranged across pixels in a specific rule/layout. An electrical characteristics of the semiconductor pattern may vary according to whether the semiconductor pattern is doped or not. The semiconductor pattern may include a first region having higher conductivity and a second region having lower conductivity. The first region may be doped with an N-type dopant or a P-type dopant. A P-type transistor may include a doped region doped with the P-type dopant, and an N-type transistor may include a doped region doped with the N-type dopant. The second region may be an undoped region or may be a region doped at a concentration lower than the concentration of the first region.

A conductivity of the first region may be greater than a conductivity of the second region. The first region may substantially function as an electrode or a signal line. The second region may correspond to an active region (or channel region) of a transistor substantially. For example, a portion of the semiconductor pattern may be an active region of a transistor, another portion thereof may be a source region or a drain region of the transistor, and another portion thereof may be a connection electrode or a connection signal line.

Each of pixels may be expressed by an equivalent circuit including seven transistors, one capacitor, and one light emitting element, and the equivalent circuit of the pixel may be modified in various forms. For example, one transistor 100PC and one light emitting element 100PE which are included in the pixel are illustrated in FIG. 6.

A source region SC, an active region AL, and a drain region DR of the transistor 100PC may be formed from the semiconductor pattern. The source region SC and the drain region DR may extend in directions facing away from each other from the active region AL in a cross-sectional view. A portion of a connection signal line SCL forming from the semiconductor pattern is illustrated in FIG. 6. For example, the connection signal line SCL may be connected to the drain region DR of the transistor 100PC in a plan view.

A first insulating layer 10 may be disposed on the buffer layer BFL. The first insulating layer 10 may overlap a plurality of pixels in common and may cover the semiconductor pattern. The first insulating layer 10 may be an inorganic layer and/or an organic layer, and may have a single-layer structure or a multilayer structure. The first insulating layer 10 may include at least one of aluminum oxide, titanium oxide, silicon oxide, silicon oxynitride, zirconium oxide, and hafnium oxide. According to the embodiment, the first insulating layer 10 may be a silicon oxide layer having a single-layer. As well as the first insulating layer 10, an insulating layer of the circuit layer 120 to be described below may be an inorganic layer and/or an organic layer and may have a single-layer structure or a multilayer structure. The inorganic layer may include at least one of the above materials, but the disclosure is not limited thereto.

A gate GT of the transistor 100PC may be disposed on the first insulating layer 10. The gate GT may be a portion of a metal pattern. The gate GT overlaps the active region AL. The gate GT may function as a mask in the process of doping the semiconductor pattern.

A second insulating layer 20 may be disposed on the first insulating layer 10 and may cover the gate GT. The second insulating layer 20 may overlap the pixels in common. The second insulating layer 20 may be an inorganic layer and/or an organic layer and may have a single-layer structure or a multiplayer structure. The second insulating layer 20 may include at least one of silicon oxide, silicon nitride, and silicon oxynitride. In an embodiment, the second insulating layer 20 may have a multilayer structure including a silicon oxide layer and a silicon nitride layer.

A third insulating layer 30 may be disposed on the second insulating layer 20, and may have a single-layer structure or a multilayer structure. In an embodiment, the third insulating layer 30 may have a multilayer structure including a silicon oxide layer and a silicon nitride layer.

A first connection electrode CNE1 may be disposed on the third insulating layer 30, and may be connected to the connection signal line SCL through a contact hole CNT-1 penetrating the first, second, and third insulating layers 10, 20, and 30.

A fourth insulating layer 40 may be disposed on the third insulating layer 30, and may be formed as a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50, and may be connected to the first connection electrode CNE1 through a contact hole CNT-2 penetrating the fourth insulating layer 40 and the fifth insulating layer 50.

A sixth insulating layer 60 may be disposed on the fifth insulating layer 50 and may cover the second connection electrode CNE2. The sixth insulating layer 60 may be formed as an organic layer.

The light emitting element layer 130 may be disposed on the circuit layer 120. The light emitting element layer 130 may include the light emitting element 100PE. For example, the light emitting element layer 130 may include an organic light emitting material, an inorganic light emitting material, an organic-inorganic light emitting material, a quantum dot, a quantum rod, a micro-LED, or a nano-LED. An example in which the light emitting element 100PE is an organic light emitting element will be described, but the disclosure is not limited thereto.

The light emitting element 100PE may include a first electrode AE, an emissive layer (e.g., a light emitting layer) EL, and a second electrode CE.

The first electrode AE may be disposed on the sixth insulating layer 60, and may be connected to the second connection electrode CNE2 through a contact hole CNT-3 penetrating the sixth insulating layer 60.

A pixel defining layer 70 may be disposed on the sixth insulating layer 60 and may cover a portion of the first electrode AE. An opening 70-OP may be defined in the pixel defining layer 70. The opening 70-OP of the pixel defining layer 70 may expose at least a portion of the first electrode AE.

The active area 1000A (refer to FIG. 1) may include an emission area PXA and a non-emission area NPXA adjacent to the emission area PXA. The non-emission region NPXA may surround the emission region PXA. In an embodiment, the emission area PXA may be defined to correspond to a partial area of the first electrode AE exposed by the opening 70-OP.

An emissive layer EL may be disposed on the first electrode AE. The emissive layer EL may be disposed in the area defined by the opening 70-OP. For example, the emissive layer EL may be independently formed for each pixel. When the emissive layer EL is independently formed for each pixel, each of the emissive layers EL may emit at least one of a blue light, a red light, and a green light. However, the disclosure is not limited thereto. For example, the emissive layer EL may be connected to the pixels in common. For example, the emissive layer EL may provide a blue light or may provide a white light.

The second electrode CE may be disposed on the emissive layer EL. The second electrode CE may be integrally disposed in a plurality of pixels in common.

For example, a hole control layer may be interposed between the first electrode AE and the emissive layer EL. The hole control layer may be disposed in common in the emission area PXA and the non-emission area NPXA. The hole control layer may include a hole transport layer and may further include a hole injection layer. An electron control layer may be disposed between the emissive layer EL and the second electrode CE. The electron control layer may include an electron transport layer and may further include an electron injection layer. The hole control layer and the electron control layer may be formed in the plurality of pixels in common by using an open mask.

The encapsulation layer 140 may be disposed on the light emitting element layer 130. The encapsulation layer 140 may include an inorganic layer, an organic layer, and an inorganic layer that are sequentially stacked with each other, but the layers of the encapsulation layer 140 are not limited thereto. The inorganic layers may protect the light emitting element layer 130 from moisture and oxygen, and the organic layer may protect the light emitting element layer 130 from a foreign material such as dust particles. The inorganic layers may include at least one of silicon nitride, silicon oxynitride, silicon oxide, titanium oxide, aluminum oxide, and/or the like. The organic layer may include an acrylic-based organic material, but the disclosure is not limited thereto.

The sensor layer 200 may include a sensor base layer 201, a first conductive layer 202, a sensing insulating layer 203, a second conductive layer 204, and a cover insulating layer 205.

The sensor base layer 201 may be an inorganic layer including at least one of silicon nitride, silicon oxynitride, and silicon oxide. In another example, the sensor base layer 201 may be an organic layer including an epoxy resin, an acrylate resin, or an imide-based resin. The sensor base layer 201 may have a single-layer structure or may have a multilayer structure in which multiple layers are stacked in the third direction DR3.

Each of the first conductive layer 202 and the second conductive layer 204 may have a single-layer structure or may have a multilayer structure in which multiple layers are stacked in the third direction DR3

A conductive layer of a single-layer structure may include a metal layer or a transparent conductive layer. The metal layer may include molybdenum, silver, titanium, copper, aluminum, or an alloy thereof. The transparent conductive layer may include transparent conductive oxide such as indium tin oxide (ITO), indium zinc oxide (IZO), zinc oxide (ZnO), or indium zinc tin oxide (IZTO). For example, the transparent conductive layer may include conductive polymer such as poly(3,4-ethylenedioxythiophene) (PEDOT), a metal nanowire, graphene, and the like.

The conductive layer of the multilayer structure may include a plurality of metal layers. The metal layers may have, for example, a three-layer structure of titanium/aluminum/titanium. The conductive layer of the multilayer structure may include at least one metal layer and at least one transparent conductive layer.

At least one of the sensing insulating layer 203 and the cover insulating layer 205 may include an inorganic layer. The inorganic layer may include at least one of aluminum oxide, titanium oxide, silicon oxide, silicon nitride, silicon oxynitride, zirconium oxide, and hafnium oxide.

At least one of the sensing insulating layer 203 and the cover insulating layer 205 may include an organic layer. The organic layer may include at least one of an acrylic-based resin, a methacrylic-based resin, polyisoprene, a vinyl-based resin, an epoxy-based resin, a urethane-based resin, a cellulose-based resin, a siloxane-based resin, a polyimide-based resin, a polyamide-based resin, and a perylene-based resin.

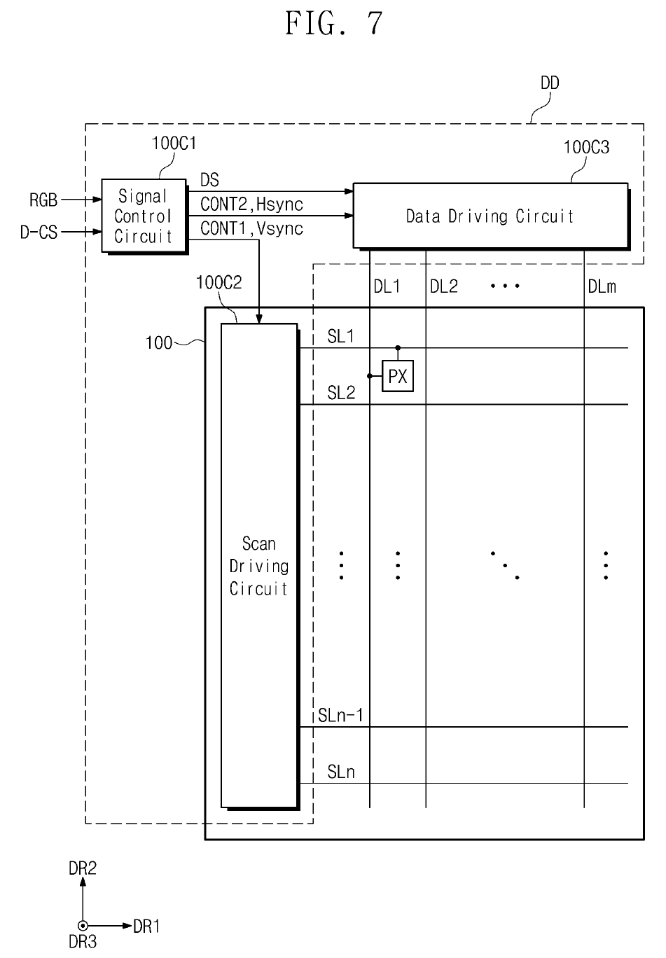

FIG. 7 is a block diagram of a display layer and a display driver according to an embodiment of the disclosure.

Referring to FIG. 7, the display layer 100 may include a plurality of scan lines SL1, SL2, ..., SLn-1, and SLn, a plurality of data lines DL1, DL2, ..., DLm, and a plurality of pixels PX. Each of the plurality of pixels PX may be connected to a corresponding data line of the plurality of data lines DL1 to DLm and may be connected to a corresponding scan line of the plurality of scan lines SL1 to SLn. In an embodiment of the disclosure, the display layer 100 may further include emission control lines, and the display driver DD may further include an emission driving circuit which provides control signals to the emission control lines. A configuration of the display layer 100 is not limited.

Each of the plurality of scan lines SL1 to SLn may extend in the first direction DR1, and the plurality of scan lines SL1 to SLn may be arranged to be spaced from each other in the second direction DR2. Each of the plurality of data lines DL1 to DLm may extend in the second direction DR2, and the plurality of data lines DL1 to DLm may be arranged to be spaced from each other in the first direction DR1.

The display driver DD may include a signal control circuit 100C1, a scan driving circuit 100C2, and a data driving circuit 100C3.

The signal control circuit 100C1 may receive the image data RGB and the control signal D-CS from the processor PR (refer to FIG. 4). The control signal D-CS may include various signals. For example, the control signal D-CS may include an input vertical synchronization signal, an input horizontal synchronization signal, a main clock, a data enable signal, and the like.

The signal control circuit 100C1 may generate a first control signal CONT1 and a vertical synchronization signal Vsync based on the control signal D-CS, and may output the first control signal CONT1 and the vertical synchronization signal Vsync to the scan driving circuit 100C2.

The signal control circuit 100C1 may generate a second control signal CONT2 and a horizontal synchronization signal Hsync based on the control signal D-CS, and may output the second control signal CONT2 and the horizontal synchronization signal Hsync to the data driving circuit 100C3.

For example, the signal control circuit 100C1 may provide the data driving circuit 100C3 with a driving signal DS that is obtained by processing the image data RGB so as to be appropriate for operating conditions of the display layer 100. The first control signal CONT1 and the second control signal CONT2 which are signals for the operations of the scan driving circuit 100C2 and the data driving circuit 100C3 are not limited.

The scan driving circuit 100C2 may drive the plurality of scan lines SL1 to SLn in response to the first control signal CONT1 and the vertical synchronization signal Vsync. In an embodiment of the disclosure, the scan driving circuit 100C2 may be formed in the same process as the circuit layer 120 (refer to FIG. 5) of the display layer 100, but the disclosure is not limited thereto. For example, the scan driving circuit 100C2 may be implemented as an integrated circuit (IC). The scan driving circuit 100C2 may be mounted (e.g., directly mounted) in a predetermined area (or certain area) of the display layer 100 or may be mounted on a separate printed circuit board in a chip-on-film (COF) scheme, and then may be electrically connected to the display layer 100.

The data driving circuit 100C3 may output grayscale voltages to the plurality of data lines DL1 to DLm in response to the second control signal CONT2 and the horizontal synchronization signal Hsync from the signal control circuit 100C1. The data driving circuit 100C3 may be implemented as an integrated circuit and may be mounted (e.g., directly mounted) on a predetermined area of the display layer 100 or on a separate printed circuit board in a chip-on-film manner to be electrically connected to the display layer 100, but is not limited thereto. For example, the data driving circuit 100C3 may be formed in the same process as the circuit layer 120 (see FIG. 5) in the display layer 100.

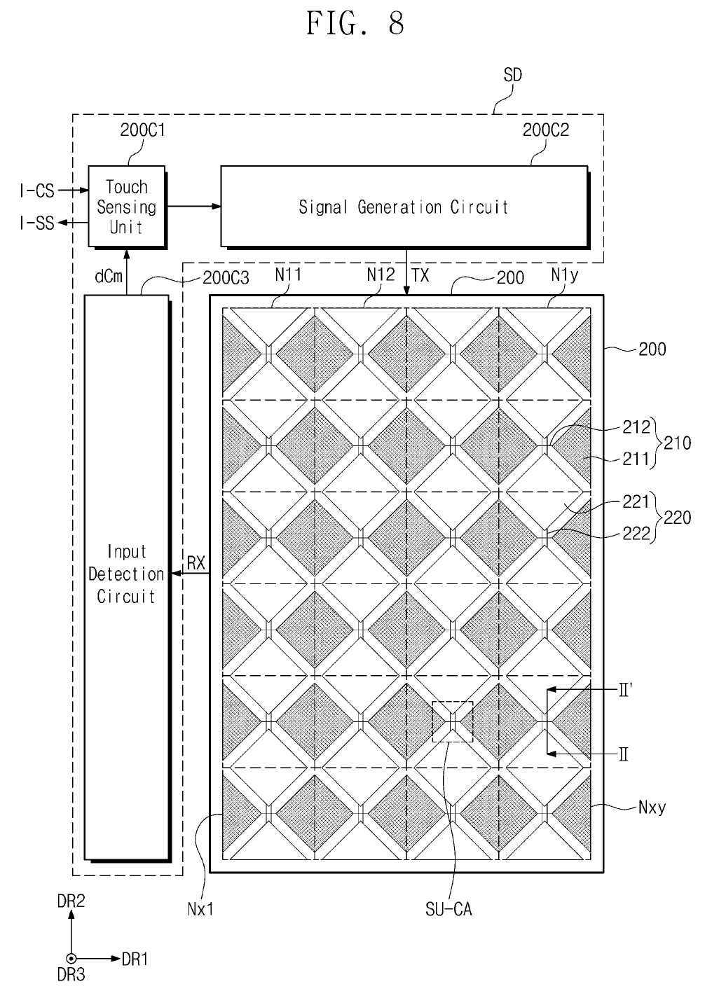

FIG. 8 is a block diagram of a sensor layer and a sensor driver according to an embodiment of the disclosure.

Referring to FIG. 8, the sensor layer 200 may include a plurality of sensing nodes N11 to Nxy. Here, ‘x’ and ‘y’ may be positive integers. The plurality of sensing nodes N11 to Nxy may be arranged in the first direction DR1 and the second direction DR2.

FIG. 8 illustrates, as an example, four sensing nodes N11, N12, ..., N1y are arranged in the first direction DR1 and six sensing nodes N11 to Nx1 are arranged in the second direction DR2. However, the number of sensing nodes N11 to Nxy is not limited thereto, and the number of sensing nodes N11 to Nxy may be greater or smaller than the number of sensing nodes illustrated in FIG. 8.

Each of the plurality of sensing nodes N11 to Nxy may include a first sensing electrode 210 extending in the first direction DR1 and a second sensing electrode 220 extending in the second direction DR2. The first sensing electrode 210 and the second sensing electrode 220 may cross each other, and may be insulated from each other.

The first sensing electrode 210 may include a plurality of first portions 211 extending in the first direction DR1 and a second portion 212 disposed between the plurality of first portions 211.

The plurality of first portions 211 and the second portion 212 may have an integrated shape. The plurality of first portions 211 and the second portion 212 may be disposed in the same layer. For example, the plurality the first portions 211 and the second portion 212 may be included in the second conductive layer 204 (refer to FIG. 6).

The second sensing electrode 220 may include a bridge pattern 222 extending in the second direction DR2 and a plurality of sensing patterns 221 connected to the bridge pattern 222 and spaced apart from each other in the second direction DR2.

The bridge pattern 222 may be provided in plurality. FIG. 8 illustrates two bridge patterns 222 as an example. Two bridge patterns 222 may be insulated from the second portion 212 and may intersect the second portion 212.

Two adjacent sensing patterns 221 may be electrically connected to each other by two bridge patterns 222, but the disclosure is not limited thereto.

The plurality of sensing patterns 221 may be included in the second conductive layer 204 (refer to FIG. 6), and the bridge pattern 222 may be included in the first conductive layer 202 (refer to FIG. 6).

The plurality of sensing patterns 221 and the bridge pattern 222 may be disposed in different layers.

The sensor layer 200 may further include a plurality of signal lines connected to the first sensing electrode 210 and the second sensing electrode 220.

The sensor driver SD may drive the sensor layer 200 in each sensing frame. The sensor driver SD may be driven in each sensing frame. The sensor driver SD may sense coordinates based on the capacitance of each of the plurality of sensing nodes N11 to Nxy in each sensing frame or each of a plurality of sensing frames. The sensor layer 200 may sense the touch input TC caused by the fingertip EI of the user in each sensing frame.

The sensor driver SD may receive the control signal I-CS from the processor PR (refer to FIG. 4) and may provide the coordinate signal I-SS to the processor PR (refer to FIG. 4).

The sensor driver SD may be implemented as an integrated circuit (IC). For electrical connection with the sensor layer 200, the IC may be mounted (e.g., directly mounted) in a certain area of the sensor layer 200 or may be mounted on a separate printed circuit board in a chip-on-film (COF) manner.

The sensor driver SD may include a touch sensor 200C1, a signal generation circuit 200C2, and an input detection circuit 200C3. The touch sensor 200C1 may control operations of the signal generation circuit 200C2 and the input detection circuit 200C3 based on the control signal I-CS.

The signal generation circuit 200C2 may sequentially output a driving signal TX to the sensor layer 200, for example, to the second sensing electrodes 220. The input detection circuit 200C3 may receive sensing signals RX from the sensor layer 200. For example, the input detection circuit 200C3 may receive the sensing signals RX from the first sensing electrodes 210. In an embodiment of the disclosure, the signal generation circuit 200C2 may sequentially output the driving signal TX to the second sensing electrodes 220, and the input detection circuit 200C3 may receive the sensing signals RX from the first sensing electrodes 210.

The input detection circuit 200C3 may convert the sensing signals RX into a plurality of capacitance change amounts dCm. For example, the sensing signals RX may be analog capacitance signals caused by the touch. The input detection circuit 200C3 may compare each analog capacitance signal with a reference value to calculate the corresponding capacitance change amount dCm of each analog capacitance signal. The input detection circuit 200C3 may include a computational circuit or an analog-to-digital (ADC) converter and may convert analog signals into digital data by using the computational circuit or the ADC converter.

Each capacitance change amount dCm may be calculated based on the mutual capacitance which is formed between the first sensing electrode 210 and the second sensing electrode 220 included in the sensor layer 200.

Accordingly, by using the mutual capacitance between sensing electrodes, the input detection circuit 200C3 may quantitatively extract the capacitance change amount dCm to determine whether an input is occurred at a corresponding location.

The reference value may be a capacitance value of each of the sensing nodes N11 to Nxy, which is measured in advance in a non-touch state, and the input detection circuit 200C3 may calculate the capacitance change amount dCm by computing a difference between the currently sensed capacitance signal and the reference value. The reference value may be updated during system initialization or during every periodic correction period and may be automatically corrected according to an environment change (e.g., a temperature, humidity, or a noise).

The plurality of sensing signals RX and the corresponding capacitance change amounts dCm respectively may correspond to the plurality of sensing nodes N11 to Nxy, respectively. The plurality of capacitance change amounts dCm may be calculated from the plurality of sensing nodes N11 to Nxy such that, for an analog capacitance signal sensed at each sensing node, a change amount obtained from the comparison with the reference value may be output in a digital form. For example, one capacitance change amount dCm may be obtained from one sensing signal RX corresponding to one sensing node. Each capacitance change amount dCm may correspond to the degree of capacitance change of each of the plurality of sensing nodes N11 to Nxy.

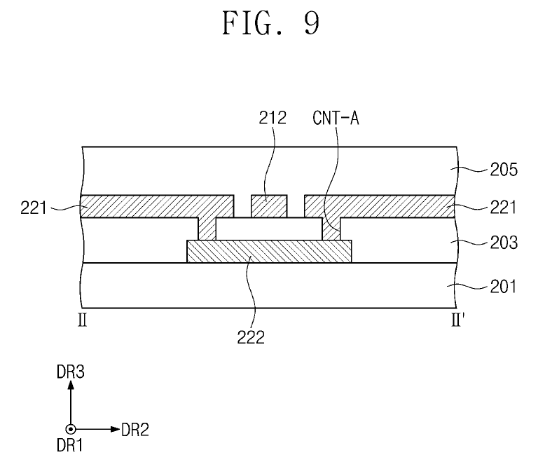

FIG. 9 is a cross-sectional view taken along line II-II’ of FIG. 8, according to an embodiment of the disclosure.

Referring to FIGS. 8 and 9, the sensor layer 200 may have a bottom bridge structure. For example, the bridge pattern 222 may be included in the first conductive layer 202 (refer to FIG. 6), and the sensing pattern 221 and the second portion 212 may be included in the second conductive layer 204 (refer to FIG. 6). The sensing pattern 221 may be connected to the bridge pattern 222 through the contact hole CNT-I penetrating the sensing insulating layer 203.

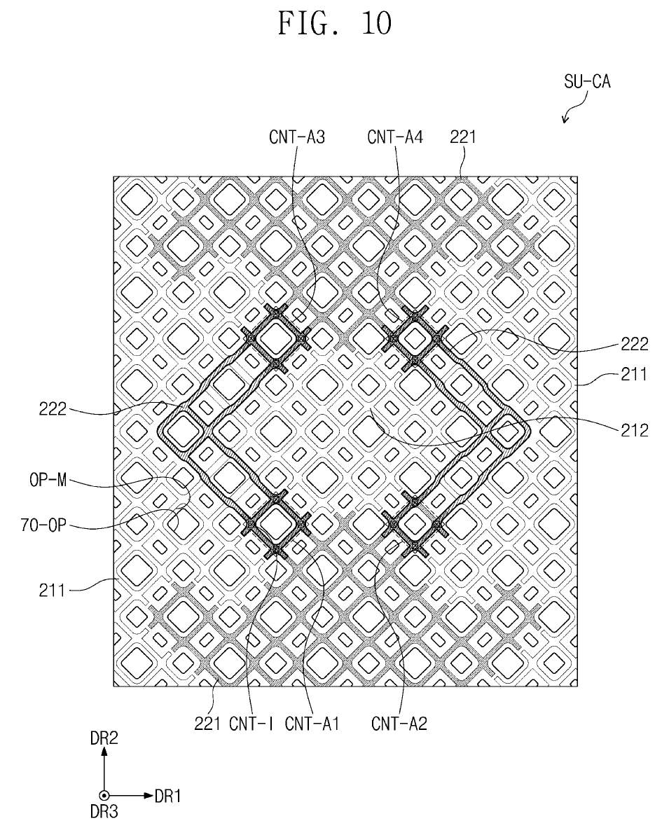

FIG. 10 is an enlarged plan view of a cross area of FIG. 8 according to an embodiment of the disclosure.

Referring to FIGS. 8 and 10, a cross area SU-CA may be an area in which a plurality of bridge patterns 222 are disposed.

Each of the plurality of sensing patterns 221 may have a mesh structure. An opening OP-M may be defined in each of the plurality of sensing patterns 221. One opening OP-M may overlap the opening 70-OP defined in the pixel defining layer 70 (refer to FIG. 6). However, this is an example. For example, one opening OP-M may overlap the plurality of openings 70-OP. Each of the plurality of first portions 211 and the second portion 212 may have a mesh structure similar to that of the plurality of sensing patterns 221.

Two bridge patterns 222 may connect two sensing patterns 221. First to fourth connection areas CNT-A1 to CNT-A4 may be provided between two bridge patterns 222 and two sensing patterns 221. Four contact holes CNT-I may be formed in the first to fourth connection areas CNT-A1 and CNT-A4, respectively. However, this is an example, and two sensing patterns 221 may be electrically connected by one bridge pattern. Also, in another embodiment, two sensing patterns 221 may be electrically connected by three or more bridge patterns.

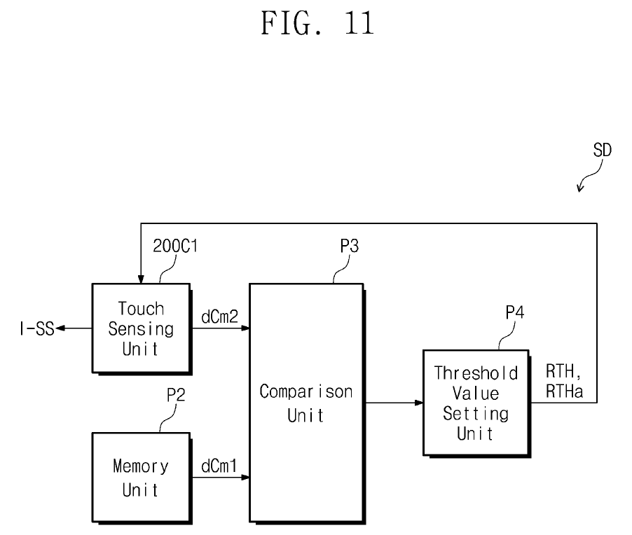

FIG. 11 is a block diagram of a sensor driver according to an embodiment of the disclosure.

Referring to FIGS. 8 and 11, the capacitance change amount dCm may be calculated in each sensing frame or each of a plurality of sensing frames. For example, the capacitance change amount dCm input during one sensing frame corresponding to a preceding time point among a plurality of sensing frames may be defined as a first capacitance change amount dCm1. The capacitance change amount dCm input during a next sensing frame following the one sensing frame may be defined as a second capacitance change amount dCm2. For example, the sensor layer 200 may sense a touch input in each sensing frame. However, this is an example, and in FIG. 11, a current capacitance change amount input during a current sensing frame is defined as the second capacitance change amount dCm2, and a previous capacitance change amount input during a previous sensing frame is defined as the first capacitance change amount dCm1. The capacitance change amount dCm which is provided in each sensing frame may change due to the interference of various environmental factors such as a temperature, humidity, and external noise. For example, in one sensing frame, the sensor layer 200 may have a first temperature; in a next sensing frame, the sensor layer 200 may have a second temperature different from the first temperature. The range of the capacitance change amount dCm may vary according to a temperature which changes in each sensing frame.

The sensor driver SD may include the touch sensor 200C1, a memory P2, a comparator P3, and a threshold value setter P4.

The touch sensor 200C1 may determine a touch start, a touch input, and a touch end (or touch release) based on the capacitance change amount dCm received from the input detection circuit 200C3. The touch sensor 200C1 may calculate coordinates of the touch input TC based on the capacitance change amount dCm received from the input detection circuit 200C3 and may provide the coordinate signal I-SS having information about the coordinates to the processor PR. The touch sensor 200C1 may provide the capacitance change amount dCm to the memory P2.

The memory P2 may store the first capacitance change amount dCm1 received during one sensing frame of the plurality of sensing frames. The one sensing frame may be a previous sensing frame.

The comparator P3 may compare the first capacitance change amount dCm1 stored in the memory P2 with the second capacitance change amount dCm2 received during a next sensing frame following the one sensing frame. The next sensing frame may be a current sensing frame. The comparator P3 may compare the first capacitance change amount dCm1 with the second capacitance change amount dCm2 and may provide the comparison result to the threshold value setter P4.

The threshold value setter P4 may change a second threshold value to a third threshold value corrected, based on the comparison result received from the comparator P3. When the second capacitance change amount dCm2 is greater than the first capacitance change amount dCm1, the threshold value setter P4 may change the second threshold value to the third threshold value.

The touch sensor 200C1 may determine the touch input (or touch start) and the touch end (or touch release) from the second capacitance change amount dCm2 based on the third threshold value thus changed.

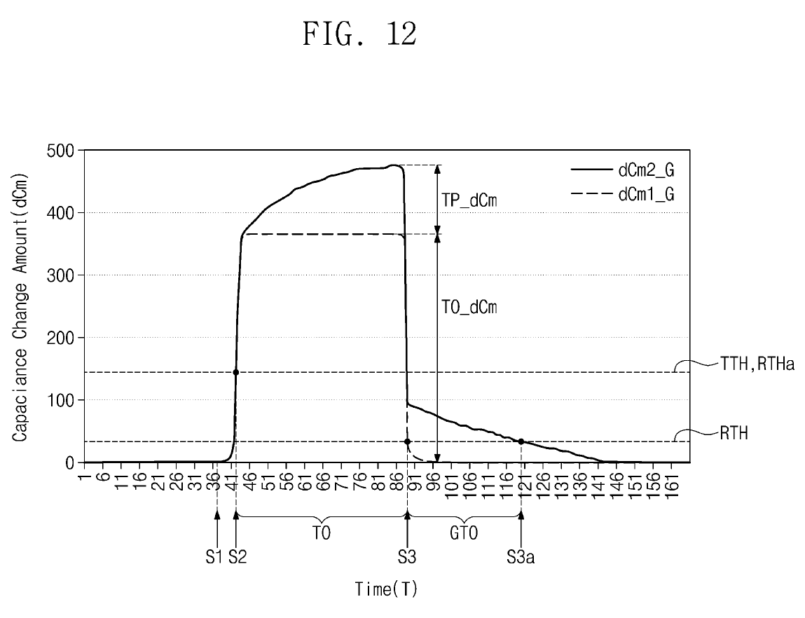

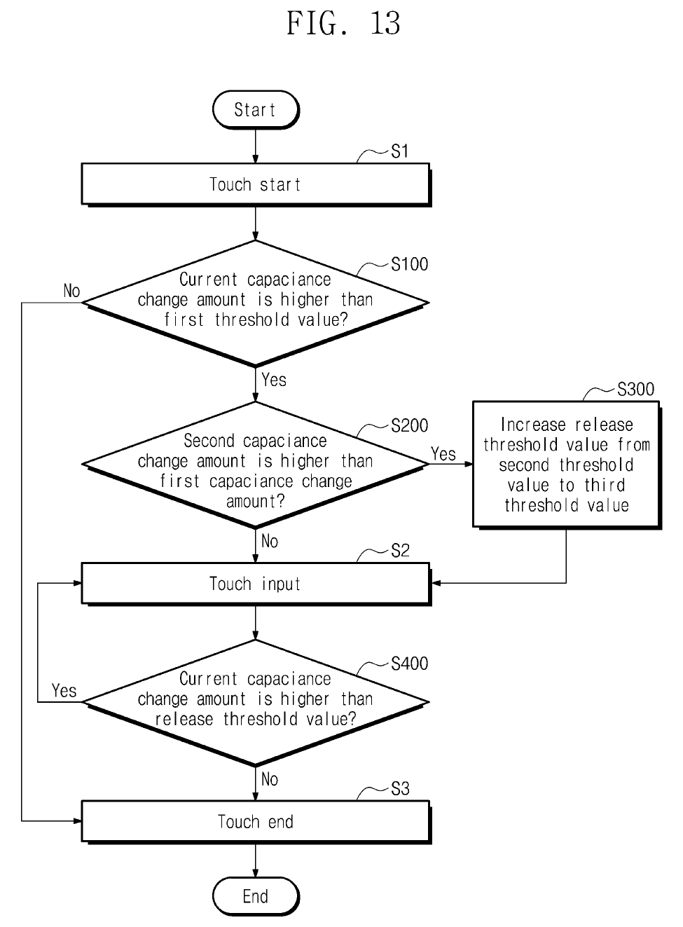

FIG. 12 is a graph illustrating a capacitance change amount for each sensing frame according to an embodiment of the disclosure. FIG. 13 is a flowchart illustrating a method of driving an electronic device according to an embodiment of the disclosure.

Referring to FIGS. 11-13, in the graph of FIG. 12, the horizontal axis represents time “T”, and the vertical axis represents the capacitance change amount dCm.

A first capacitance graph dCm1_G represents a graph showing the first capacitance change amount dCm1 measured over time from one sensing frame defined as a reference time point (or reference frame) among a plurality of sensing frames, when the sensor layer 200 is at the first temperature.

A second capacitance graph dCm2_G represents a graph showing the second capacitance change amount dCm2 continuously measured over time from another sensing frame defined as a reference time point (or reference frame) among the plurality of sensing frames, when the sensor layer 200 is at the second temperature. The second capacitance change amount dCm2 may be greater than the first capacitance change amount dCm1.

The input detection circuit 200C3 (refer to FIG. 8) may provide the touch sensor 200C1 with the capacitance change amount dCm having a shape of the first capacitance graph dCm1_G or the second capacitance graph dCm2_G. For example, the touch sensor 200C1 may receive the first capacitance graph dCm1_G and the second capacitance graph dCm2_G from the input detection circuit 200C3 (refer to FIG. 8).

For example, two graphs dCm1_G and dCm2_G may be used to chronologically or sequentially compare the characteristics of capacitance variation according to a temperature change under the condition that the same fingertip EI (refer to FIG. 4) contacts the sensor layer 200.

The second temperature may be higher than the first temperature. According to an embodiment, the second temperature may be 55 ℃, and may be regarded as a high temperature according to a general operation reliability test condition of a display device. The high temperature may generally refer to 55 °C or higher. The first temperature may be a temperature below 55 °C, which is not regarded as a high temperature.

However, the temperature values are examples. The first temperature and the second temperature may be variously set, and the disclosure is not thereto.

The method of driving the electronic device according to an embodiment may include a step of determining a touch input S2 from the first capacitance change amount dCm1 based on a first threshold value TTH and determining a touch end (or touch release) S3 based on a second threshold value RTH, a step of storing the first capacitance change amount dCm1 in the memory P2, a step S200 of comparing, at the comparator P3, the first capacitance change amount dCm1 with the second capacitance change amount dCm2, a step S300 of changing, at the threshold value setter P4, the second threshold value RTH to a third threshold value RTHa based on the result of the comparison by the comparator P3, and a step S400 of determining the touch input S2 from the second capacitance change amount dCm2 based on the first threshold value TTH and determining the touch end S3 based on the third threshold value RTHa.

A signal corresponding to the first capacitance graph dCm1_G may be a signal which is received from the sensor driver SD when the sensor layer 200 (refer to FIG. 8) is at the first temperature. A method of sensing a touch by using the first capacitance graph dCm1_G will be described.

In the event that the first capacitance change amount dCm1 exceeds zero, the touch sensor 200C1 may determine that a touch start S1 is occurred. For example, when there occurs the event that the sensor layer 200 is touched by the fingertip EI (refer to FIG. 4), the first capacitance change amount dCm1 increases, and the first capacitance change amount dCm1 exceeds zero, the event may be regarded as the touch start S1.

After the touch start S1, the touch sensor 200C1 may compare the first capacitance change amount dCm1 with the first threshold value TTH (S100). The first threshold value TTH may have a value greater than “0”. For example, the first threshold value TTH may be 37.5.

When there occurs the event that the first capacitance change amount dCm1 is equal to the first threshold value TTH or is lower than the first threshold value TTH, the touch sensor 200C1 may determine that the touch end S3 is occurred.

When the first capacitance change amount dCm1 is greater than the first threshold value TTH, the comparator P3 may compare a current capacitance change amount with a previous capacitance change amount (S200). For example, the current capacitance change amount may be the first capacitance change amount dCm1, and the previous capacitance change amount may be a capacitance change amount of a previous sensing frame, which is stored in the memory P2.

When the current capacitance change amount is equal to the previous capacitance change amount or is lower than the previous capacitance change amount, the threshold value setter P4 may not perform a separate operation. For example, the threshold value setter P4 may maintain the second threshold value RTH without change.

When there occurs the event that the first capacitance change amount dCm1 is greater than the first threshold value TTH, the touch sensor 200C1 may determine that the touch input S2 is occurred. The first capacitance change amount dCm1 may increase by a touch change amount TO_dCm caused by the fingertip EI (refer to FIG. 4) after the touch input S2. For example, the touch change amount TO_dCm may be 470.

In the first capacitance graph dCm1_G, the value increased by the touch change amount TO_dCm may be uniformly maintained until the user releases the fingertip EI (refer to FIG. 4).

After the touch input S2, the touch sensor 200C1 may compare the first capacitance change amount dCm1 with the second threshold value RTH (S400). The second threshold value RTH may be referred to as a “release threshold value”. The second threshold value RTH may be less than the first threshold value TTH. The second threshold value RTH may be greater than “0”. For example, the second threshold value RTH may be 140.

When the first capacitance change amount dCm1 is greater than the second threshold value RTH, the touch sensor 200C1 may maintain the state of the touch input S2.

When there occurs the event that the first capacitance change amount dCm1 is lower than the second threshold value RTH, the touch sensor 200C1 may determine that the touch end (or touch release) S3 is occurred. For example, the capacitance change amount dCm may decrease when the user releases the fingertip EI (refer to FIG. 4), and when there occurs the event that the capacitance change amount dCm is lower than the second threshold value RTH, the event may be regarded as the touch end S3.

A period from the touch input S2 to the touch end S3 may be referred to as a “touch recognition period T0”.

The first capacitance change amount dCm1 may immediately fall below the second threshold value RTH when the user releases the fingertip EI (refer to FIG. 4) and may be regarded as the touch end S3.

The first capacitance change amount dCm1 may be stored in the memory P2.

A signal corresponding to the second capacitance graph dCm2_G may be a signal which is received from the sensor driver SD when the sensor layer 200 (refer to FIG. 8) is at the second temperature. A method of sensing a touch by using the second capacitance graph dCm2_G will be described.

When there occurs the event that the second capacitance change amount dCm2 exceeds zero, the touch sensor 200C1 may determine that the touch start S1 is occurred. For example, when there occurs the event that the sensor layer 200 is touched by the fingertip EI (refer to FIG. 4), the second capacitance change amount dCm2 increases, and the second capacitance change amount dCm2 exceeds zero, the event may be regarded as the touch start S1.

After the touch start S1, the touch sensor 200C1 may compare the second capacitance change amount dCm2 with the first threshold value TTH (S100). The first threshold value TTH may have a value greater than “0”.

When there occurs the event that the second capacitance change amount dCm2 is equal to the first threshold value TTH or is lower than the first threshold value TTH, the touch sensor 200C1 may determine that the touch end S3 is occurred.

When the second capacitance change amount dCm2 is greater than the first threshold value TTH, the comparator P3 may compare a current capacitance change amount with a previous capacitance change amount (S200). For example, the current capacitance change amount may be the second capacitance change amount dCm2, and the previous capacitance change amount may be the first capacitance change amount dCm1 stored in the memory P2.

When the second capacitance change amount dCm2 is greater than the first capacitance change amount dCm1, the threshold value setter P4 may change the second threshold value RTH to the third threshold value RTHa. The third threshold value RTHa may be greater than the second threshold value RTH.

When there occurs the event that the second capacitance change amount dCm2 is greater than the first threshold value TTH, the touch sensor 200C1 may determine that the touch input S2 is occurred. The second capacitance change amount dCm2 may increase by the touch change amount TO_dCm caused by the fingertip EI (refer to FIG. 4) after the touch input S2.

However, in the second capacitance graph dCm2_G, a capacitance change amount may be increased by the touch change amount TO_dCm and may then be further increased by a temperature change amount TP_dCm. For example, the temperature change amount TP_dCm may be 94. This may correspond to a difference between the first capacitance graph dCm1_G and the second capacitance graph dCm2_G. Referring to the second capacitance graph dCm2_G, under the condition that the same fingertip EI (refer to FIG. 4) as the first capacitance graph dCm1_G is contacted, after the second capacitance change amount dCm2 increases by the touch change amount TO_dCm, the second capacitance change amount dCm2 may further increase by the temperature change amount TP_dCm due to the second temperature, e.g., the influence of the high-temperature environment.

The reason may be that a temperature of an area contacted by the fingertip EI (refer to FIG. 4) becomes relatively lower than the entire high surface temperature of the sensor layer 200 in the high-temperature environment, thereby causing a local temperature difference. Thus, the permittivity of the contact area decreases as its temperature drops. For example, a temperature of the sensor layer 200 (refer to FIG. 4) in the contact area may decrease to a range of 30°C to 35°C due to the influence of the fingertip EI. Because the capacitance is proportional to the permittivity, a capacitance value may decrease as the permittivity decreases. The decrease in the capacitance may result in an increase in the absolute value of the capacitance change amount dCm (refer to FIG. 8). The capacitance change amount dCm (refer to FIG. 8) may gradually increase over time.

Accordingly, in the second capacitance graph dCm2_G, in addition to the change due to the touch, the change in capacitance due to the high-temperature environment may be additionally applied together. This may be closely related to the probability of occurrence of a ghost touch in the high-temperature environment. The ghost touch will be described below.

After the touch input S2, the touch sensor 200C1 may compare the second capacitance change amount dCm2 with the third threshold value RTHa (S400). The third threshold value RTHa may be referred to as a “release threshold value”. The third threshold value RTHa and the first threshold value TTH may be the same as each other. The third threshold value RTHa may be greater than “0”. For example, the third threshold value RTHa may be 140. However, this is an example, and the third threshold value RTHa according to an embodiment of the disclosure may be variously defined as long as the third threshold value RTHa is greater than the first threshold value TTH.

When the second capacitance change amount dCm2 is greater than the third threshold value RTHa, the touch sensor 200C1 may maintain the state of the touch input S2.

When there occurs the event that the second capacitance change amount dCm2 is lower than the third threshold value RTHa, the touch sensor 200C1 may determine that the touch end S3 is occurred. For example, the capacitance change amount dCm may decrease when the user releases the fingertip EI (refer to FIG. 4), and when there occurs the event that the capacitance change amount dCm is lower than the third threshold value RTHa, the event may be regarded as the touch end S3. In the touch recognition period T0, the second capacitance change amount dCm2 may be greater than the first capacitance change amount dCm1.

Unlike the disclosure, when the release threshold value of the touch is not switched based on the comparison of the current capacitance change amount and the previous capacitance change amount, the second capacitance change amount dCm2 may additionally increase by the temperature change amount TP_dCm. For example, the second capacitance change amount dCm2 may not immediately fall below the second threshold value RTH when the user releases the fingertip EI (refer to FIG. 4). For example, the touch may not end (or released), and the touch recognition period T0 may continue. Then, the second capacitance change amount dCm2 may decrease while a given time passes. When there occurs the event that the value of the second capacitance change amount dCm2 is lower than the second threshold value RTH, the event may be determined as a detected touch end S3a. For example, a time point at which the detected touch end S3a is determined in the environment corresponding to the second temperature may be delayed with respect to a time point at which the touch end S3 is determined in the environment corresponding to the first temperature. As described above, even though the fingertip EI (refer to FIG. 4) is actually or physically released from the sensor layer 200 (refer to FIG. 4), the phenomenon that a touch recognition state continues during a given period GT0 may be referred to as a “ghost touch”. The ghost touch may be regarded as a representative example of an error in the error history, which causes an abnormal operation of a system.

However, according to the disclosure, when the comparator P3 determines that the second capacitance change amount dCm2 is greater than the first capacitance change amount dCm1 in the touch recognition period T0, the threshold value setter P4 may change the second threshold value RTH to the third threshold value RTHa. Referring to the graph of the second capacitance change amount dCm2, the third threshold value RTHa and the first threshold value TTH may be the same as each other. As the second threshold value RTH is changed to the third threshold value RTHa, the increased temperature change amount TP_dCm of the second capacitance change amount dCm2 may be compensated for. Accordingly, the touch end S3 may be immediately determined when the fingertip EI (refer to FIG. 4) is released.

The above correction manner may make it possible to effectively prevent the ghost touch phenomenon capable of occurring due to a change of an external environment such as an increase in a temperature, to improve the reliability of touch recognition, and to reduce the failure rate. For example, the above correction manner may contribute to improving environment adaptability and sensing reliability of the electronic device according to the disclosure.

According to the above description, when a comparator determines that a second capacitance change amount is greater than a first capacitance change amount in a touch recognition period, a threshold value setter may change a second threshold value to a third threshold value. The above correction manner may make it possible to effectively prevent the ghost touch phenomenon, which is caused by a change of an external environment such as an increase in a temperature, to improve the reliability of touch recognition, and to reduce the failure rate. For example, the above correction manner may contribute to improving environment adaptability and sensing reliability of the electronic device according to the disclosure.

According to the above description, as a step of comparing, at the comparator, the first capacitance change amount with the second capacitance change amount may be added, whether the capacitance change amount is increased abnormally due to a temperature may be determined. Accordingly, an electronic device according to the disclosure may provide a user interface which is stable even in a high-temperature environment.

At least one of the components, elements, modules, units, or the like (collectively "components" in this paragraph) represented by a block or an equivalent indication (collectively “block”) in the above embodiments including the drawings, for example, FIGS. 1, 4, 7, 8 and 11, may be physically implemented by analog and/or digital circuits including one or more of a logic gate, an integrated circuit, a microprocessor, a microcontroller, a memory circuit, a passive electronic component, an active electronic component, an optical component, and the like, and may be driven by software and/or firmware implemented by computer instruction codes stored in one or more internal or external memories to perform the functions or operations described herein. These components may, for example, be embodied in one or more semiconductor chips, or on substrate supports such as printed circuit boards and the like. These circuits may also be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. An electronic device comprising:
a display layer;
a sensor layer on the display layer, and configured to sense a touch in each of a plurality of sensing frames; and
a sensor driver configured to drive the sensor layer,
wherein the sensor driver comprises:
a touch sensor configured to determine a touch input based on a first capacitance change amount received during a first sensing frame of the plurality of sensing frames based on a first threshold value and to determine a touch end based on a second threshold value being less than the first threshold value;
a memory configured to store the first capacitance change amount;
a comparator configured to compare the first capacitance change amount stored in the memory with a second capacitance change amount received during a second sensing frame of the plurality of sensing frames; and
a threshold value setter configured to change the second threshold value to a third threshold value, based on the second capacitance change amount being greater than the first capacitance change amount,
wherein, during the second sensing frame, the touch sensor is configured to determine the touch input based on the second capacitance change amount based on the first threshold value and to determine the touch end based on the third threshold value.

2. The electronic device of claim 1, wherein the sensor layer comprises:
a first sensing electrode extending in a first direction; and
a second sensing electrode extending in a second direction intersecting the first direction.

3. The electronic device of claim 2, wherein the first sensing electrode comprises a plurality of first portions extending in the first direction and a second portion between the plurality of first portions, and
wherein the plurality of first portions and the second portion are in the same layer.

4. The electronic device of claim 2, wherein the second sensing electrode comprises a bridge pattern extending in the second direction and a plurality of sensing patterns connected to the bridge pattern and spaced apart in the second direction, and
wherein the plurality of sensing patterns and the bridge pattern are in different layers.

5. The electronic device of claim 2, wherein the first capacitance change amount or the second capacitance change amount is calculated based on a mutual capacitance between the first sensing electrode and the second sensing electrode.

6. The electronic device of claim 1, wherein the third threshold value is equal to the first threshold value.

7. The electronic device of claim 1, wherein, based on an event that the first capacitance change amount or the second capacitance change amount exceeds zero, the touch sensor is configured to determine that a touch start is occurred.

8. The electronic device of claim 1, wherein the sensor layer has a first temperature during the first sensing frame, and
wherein the sensor layer has a second temperature higher than the first temperature during the second sensing frame.

9. The electronic device of claim 8, wherein the first capacitance change amount increases by a touch change amount after a touch start.

10. The electronic device of claim 9, wherein the second capacitance change amount increases by the touch change amount after the touch start and then further increases by a temperature change amount based on the second temperature.

11. The electronic device of claim 1, wherein, after the touch end, the second capacitance change amount is greater than or equal to the second threshold value and less than or equal to the third threshold value.

12. The electronic device of claim 1, wherein, based on an event that the first capacitance change amount or the second capacitance change amount is lower than the first threshold value during determination of the touch input, the touch sensor is configured to determine that the touch end is occurred.

13. The electronic device of claim 1, wherein, based on the second capacitance change amount being greater than the first capacitance change amount, the threshold value setter is configured to change the second threshold value to the third threshold value.

14. The electronic device of claim 2, wherein the sensor driver further comprises:
a signal generation circuit configured to output a driving signal to the first sensing electrode; and
an input detection circuit configured to receive a sensing signal from the second sensing electrode,
wherein the input detection circuit is configured to convert the sensing signal into the first capacitance change amount or the second capacitance change amount.

15. A method of driving an electronic device, the method comprising:
determining a touch input based on a first capacitance change amount received during a first sensing frame of a plurality of sensing frames based on a first threshold value and determining a touch end based on a second threshold value less than the first threshold value;
storing the first capacitance change amount;
comparing the first capacitance change amount with a second capacitance change amount received during a second sensing frame of the plurality of sensing frames;
changing the second threshold value to a third threshold value, based on the second capacitance change amount being greater than the first capacitance change amount; and
determining the touch input based on the second capacitance change amount received during the second sensing frame based on the first threshold value and determining the touch end based on the third threshold value.

16. The method of claim 15, wherein the determining of the touch input based on the first capacitance change amount and the determining of the touch end comprises:
outputting a driving signal to the plurality of sensing frames;
receiving a sensing signal based on the driving signal; and
converting the sensing signal into the first capacitance change amount or the second capacitance change amount.

17. The method of claim 15, further comprising:
determining a touch start based on an event that the first capacitance change amount or the second capacitance change amount exceeds zero.

18. The method of claim 15, wherein the determining of the touch input based on the first capacitance change amount and the determining of the touch end comprises:
determining the touch end based on an event that the first capacitance change amount is lower than the first threshold value during determination of the touch input.

19. The method of claim 15, wherein the comparing of the first capacitance change amount with the second capacitance change amount received during the second sensing frame of the plurality of sensing frames comprises:
changing the second threshold value to the third threshold value, based on the second capacitance change amount being greater than the first capacitance change amount.

20. An electronic device comprising:
a sensor layer configured to sense a touch; and
a control circuit configured to:
detect a first capacitance change amount caused by the touch during a first sensing frame;
detect a second capacitance change amount caused by the touch during a second sensing frame;
compare the second capacitance change amount with the first capacitance change amount;
increase a threshold value based on the second capacitance change amount being greater than the first capacitance change amount; and
determine a touch end based on the increased threshold value,
wherein the increased threshold value is determined to compensate for a capacitance variation of the sensor layer corresponding to a temperature change of the sensor layer caused by the touch.
